(19) United States
(12) Patent Application Publication
(10) Pub. No.: US 2023/0356383 A1
(43) Pub. Date: Nov. 9, 2023

(54) BIODEGRADABLE HAND GRIP

(71) Applicants: Ryan Burbary, Centennial, CO (US); Adam Burbary, Centennial, CO (US); Carl David Bodem, Boulder, CO (US)

(72) Inventors: Ryan Burbary, Centennial, CO (US); Adam Burbary, Centennial, CO (US); Carl David Bodem, Boulder, CO (US)

(21) Appl. No.: 18/310,199

(22) Filed: May 1, 2023

Related U.S. Application Data
(60) Provisional application No. 63/364,039, filed on May 3, 2022.

(51) Int. Cl. B25G 1/10; A63B 49/08; A63B 53/14; A63B 49/10

(52) U.S. Cl. CPC B25G 1/10; A63B 49/08; A63B 53/14; A63B 49/10

(57) ABSTRACT

Biodegradable handgrips, for example, for use in racquet sports, baseball bats, golf clubs, fishing poles, bicycle handlebars, and hand tools, are described. The biodegradable handgrips includes a petroleum based material and a biodegradable additive blended with the petroleum based material. The petroleum based material may be nylon, polyester, or polyurethane, and the biodegradable additive may be less than 5% of the handgrip by weight. The biodegradable handgrip may be shaped as a tape that is wrapped around a handle or a sheath that slides over a handle.

### CROSS REFERENCES

The present Application for Patent claims priority to U.S. Provisional Patent Application No. 63/364,039 by Burbary et al., entitled “BIODEGRADABLE HANDGRIP,” filed May 3, 2022, which is expressly incorporated by reference herein.

### FIELD OF TECHNOLOGY

The present disclosure relates generally to synthetically manufactured handgrips.

### BACKGROUND

Synthetic grips, such as those used in racquets (e.g., tennis racquets, racquetball rackets, squash racquets, badminton racquets, etc.), golf clubs, baseball bats, and hand tools (e.g., hammers, mallets, screwdrivers, axes, etc.,) may be manufactured by mixing, heating, and extruding a plastic polymer into a desired shape and size. Synthetic handgrips may generate waste in the form of plastic.

### SUMMARY

The systems, methods and devices of this disclosure each have several innovative aspects, no single one of which is solely responsible for the desirable attributes disclosed herein.

The described techniques relate to improved devices, apparatuses, methods, and systems, that support biodegradable handgrips, among other examples. Generally, the described techniques provide for a biodegradable handgrip comprising a petroleum based material and a biodegradable additive blended with the petroleum based material.

A biodegradable handgrip is described. The biodegradable handgrip may include a petroleum based material and a biodegradable additive blended with the petroleum based material, where the biodegradable handgrip is configured to wrap around a shaft.

In some examples of the biodegradable handgrip described herein, the biodegradable additive may be between 0.2 percent and 4 percent of the biodegradable handgrip by weight.

In some examples of the biodegradable handgrip described herein, the petroleum based material may be one of nylon, polyester, or polyurethane.

In some examples of the biodegradable handgrip described herein, an inner side of the sleeve shape includes an adhesive material.

In some examples of the biodegradable handgrip described herein, the biodegradable handgrip includes an approximately rectangular strip.

In some examples of the biodegradable handgrip described herein, the biodegradable handgrip includes an adhesive material on a first side of the approximately rectangular strip.

In some examples of the biodegradable handgrip described herein, the biodegradable handgrip includes a color additive.

In some examples of the biodegradable handgrip described herein, the biodegradable handgrip may be a racquet base grip.

In some examples of the biodegradable handgrip described herein, the biodegradable handgrip may be a racquet overgrip.

In some examples of the biodegradable handgrip described herein, the biodegradable handgrip may be a golf club grip.

In some examples of the biodegradable handgrip described herein, the biodegradable handgrip may be a hand tool grip.

### BRIEF DESCRIPTION OF THE DRAWINGS

FIG. 1 illustrates a racquet including a biodegradable handgrip in accordance with aspects of the present disclosure.

FIGS. 2A-2B illustrates several cross-sectional views of a biodegradable handgrip in accordance with aspects of the present disclosure.

FIG. 3 illustrates a golf club including a biodegradable handgrip in accordance with aspects of the present disclosure.

FIG. 4 illustrates a mallet including a biodegradable handgrip in accordance with aspects of the present disclosure.

FIG. 5 illustrates images of samples subject to a abrasion test in accordance with aspects of the present disclosure.

### DETAILED DESCRIPTION

Synthetic handgrips are commonly used for many products, as synthetic grips may be generally durable, may be manufactured easily at low cost, may provide tackiness for non-slip grip, may provide cushioning for a comfortable grip, may be ergonomically formed, and may be used in various industries. For example, synthetic handgrips may be used for racquets (e.g., for tennis racquets, racquetball racquets, squash racquets, badminton racquets, etc.), golf clubs, baseball bats, bicycle handlebar grips, hockey sticks, or hand tools (e.g., hammers, mallets, axes, screwdrivers, wrenches, etc.). Synthetic handgrips may be manufactured by mixing, heating, and extruding a petroleum based material into a desired size and shape. Synthetic handgrips may be nonrecyclable or may have a long degradation lifetime (e.g., hundreds or thousands of years). In some cases, a handgrip may be formed as a tape (e.g., a rectangular strip) that may be wrapped around a shaft or handle of a racquet, bat, golf club, fishing pole, bicycle handlebar, hockey stick, or hand tool. A tape material may include an adhesive material on one side to adhere to the shaft or handle of the racquet, bat, golf club, fishing pole, bicycle handlebar, hockey stick, or hand tool. In some cases, a synthetic handgrip may be formed as a sheath that may slide over a shaft or handle of a racquet, bat, fishing pole, bicycle handlebar, golf club, hockey stick, or hand tool and encase or wrap around the shaft. In some cases, synthetic handgrips may be formed into ergonomic shapes. In some cases, synthetic handgrips may be molded onto handles or shafts of equipment during a manufacturing process of the equipment.

Synthetic handgrips may wear down over time with use. For example, synthetic handgrips may lose tackiness, stickiness, cushion, or traction over time with use, which may decrease the effectiveness of the handgrip and the associated racquet, bat, golf club, fishing pole, bicycle handlebar, hockey stick, or hand tool. As another example, synthetic handgrip material may shed or lose material over time due to abrasion or moisture during use, which may affect tackiness, stickiness, cushion, or traction of the handgrip.

Some plastics (e.g., petroleum based materials) may be biodegradable. For example, biodegradable plastic may be made of bioplastics, where the components are derived from renewable raw materials, or plastics made from petrochemicals with biodegradable additives that enhance the biodegradation of the polymers by allowing microorganisms to utilize the carbon within the polymer chain as a source of energy. Examples of biodegradable additives include starches, certain microbial strains, and pro oxidant additives (e.g., iron, manganese, and cobalt). However, current synthetic handgrips do not include biodegradable additives and therefore generate plastic waste once discarded. In some applications, synthetic handgrips may frequently be replaced (e.g., due to frequent use). For example, racquet overgrips may be replaced multiple times during a match. Accordingly, synthetic handgrips may contribute significant plastic waste.

In accordance with aspects of the present disclosure, synthetic handgrips (e.g., for use in racquet sports, golf clubs, bicycle handlebars, fishing poles, baseball bats, hockey sticks, or hand tools) may be manufactured using a petroleum based material and a biodegradable additive blended with the petroleum based material. The addition of the biodegradable additive may result in the synthetic handgrip having a significantly shorter degradation lifetime relative to traditional petroleum based handgrips. In some examples, the biodegradable handgrip may biodegrade in approximately 3 to 5 years. For example, an ethylene-vinyl acetate foam tennis racquet grip with a biodegradable additive has been shown to biodegrade by 67% within 300 days. The addition of a biodegradable additive may not change the manufacturing process of synthetic handgrip aside from the addition of the biodegradable additive during the mixing process. In some cases, for example during an extrusion process, biodegradable handgrips may be formed into a desired shape and size. Additionally, biodegradable synthetic handgrips may have other unexpected advantages beyond biodegradability, not limited to greater durability.

Aspects of the disclosure are initially described in the context of racquets and handgrips for racquets. Aspects of the disclosure are further illustrated by and described with reference to cross sectional views of handgrips, golf clubs and handgrips for golf clubs, hand tools and handgrips for hand tools, and samples subject to an abrasion test.

This description provides examples, and is not intended to limit the scope, applicability or configuration of the principles described herein. Rather, the ensuing description will provide those skilled in the art with an enabling description for implementing various aspects of the principles described herein. As can be understood by one skilled in the art, various changes may be made in the function and arrangement of elements without departing from the application.

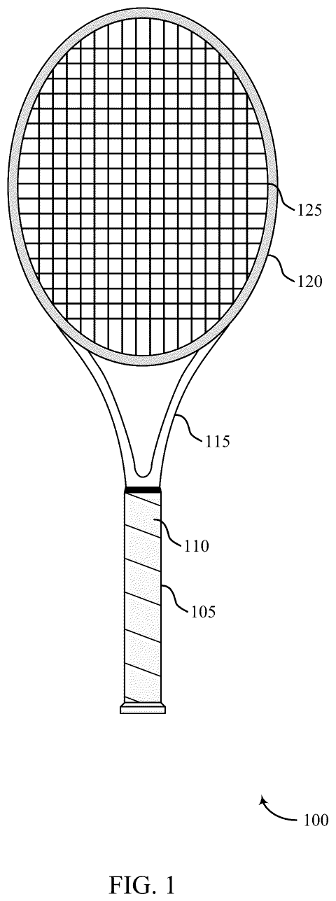

FIG. 1 illustrates an example racquet 100 that supports a biodegradable handgrip 105 in accordance with aspects of the present disclosure. The example racquet 100 may be an example of any racquet utilized in racquet sports, such as a tennis racquet, racquetball racquet, squash racquet, or badminton racquet. The racquet 100 may include a frame including a head 120, a throat 115, and a handle or shaft 110, where the head 120 is connected to the handle 110 via the throat 115. The racquet string 125 may be threaded through the head 120 of the racquet via openings in the head 120.

The biodegradable handgrip 105 may include a base grip or an overgrip wrapped over the base grip. The biodegradable handgrip 105 be manufactured using conventional techniques aside from the addition of a biodegradable additive. In some cases, the biodegradable handgrip 105 may be formed as a tape (e.g., a rectangular strip) with an adhesive side that is wrapped around the handle 110. In some cases, the biodegradable handgrip 105 may be formed as a sheath that slides over the handle 110. In some cases, an inner surface of a sheath shaped handgrip 105 may include an adhesive material to prevent the sheath shaped handgrip 105 from sliding on the handle 110. The biodegradable handgrip 105 may be manufactured by blending petroleum based material and a biodegradable additive under high temperatures, then extruding the blended material into a desired shape and size (e.g., a tape or sheath of a desired width and thickness). In some aspects, the biodegradable handgrip 105 may be molded onto the handle 110 during a manufacturing process.

As described herein, the petroleum based material may be blended with a biodegradable additive under high temperatures and then extruded to a desired size and shape (e.g., a tape or sheath of a desired width and thickness). In some examples, the petroleum based material may be one of nylon, polyester, vinyl, or polyurethane. In some examples, the biodegradable additive may be between 0.2% and 4% of the handgrip 105 (e.g., the total blended mixture of the petroleum based material and the biodegradable additive) by weight. In some examples, the blended mixture of petroleum based material and the biodegradable additive may further include one or more color additives. In some cases, no color additives may be included.

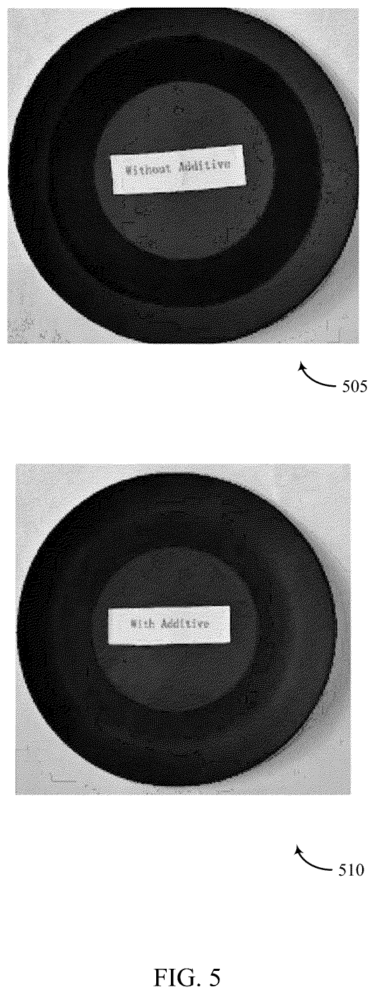

The addition of the biodegradable additive to synthetic handgrip 105 has been shown to increase the durability of the synthetic handgrip. For example, a biodegradable synthetic handgrip 105 including a biodegradable additive was tested under a Taber abrasion test. As described with reference to FIG. 5, synthetic handgrips 105 with a biodegradable additive have been shown to perform better under a Taber abrasion test as compared to synthetic handgrips without a biodegradable additive. When applied to racquet grips, increased durability may result in less frequent changing of racquet grips 105, which may result in time saving, cost saving, and in less plastic waste. Further, increase in durability of the handgrip 105 may result in increased consistency in the feel of the grip to a user.

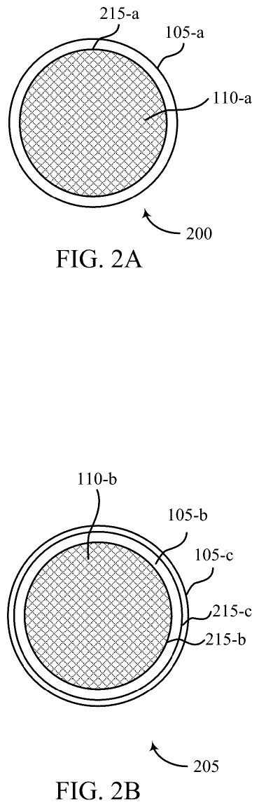

FIG. 2A illustrate a cross-sectional view 200 of a biodegradable handgrip 105-a (e.g., a grip for a racquet) in accordance with aspects of the present disclosure. As illustrated, a biodegradable base handgrip 105-a may wrap around a handle 110-a (e.g., of a racquet). In some examples, the handgrip 105-a may be shaped as a tape and in inner surface 215-a of the tape may include an adhesive substance or material in order to adhere the handgrip 105-a to the handle 110-a. In some examples, the thickness of the handgrip may be approximately 1/16 to ¼ inches. In some examples, the handgrip 105-a may be shaped as a sheath that slides over the handle 110-a.

FIG. 2B illustrate a cross-sectional view 205 of a biodegradable base grip 105-b and a biodegradable overgrip 105-c in accordance with aspects of the present disclosure. An overgrip 105-c may generally have a thinner thickness than the base grip 105-b. For example, an overgrip may be approximately 1/16 inch thick and a base grip may be approximately 1/16 to ¼ inches thick. A overgrip 105-c may be wrapped over a base grip 105-b, and the base grip 105-b may be wrapped over the handle 110-b (e.g., of a racquet). Either or both of the base grip 105-b or the overgrip 105-b may be shaped as a tape (e.g., a rectangular strip) that is wrapped over the handle 110-b or a sheath that slides over the handle 110-b. In some examples, an inner surface 215-b of the base grip 105-b may include an adhesive substance or material in order to adhere the base grip 105-b to the handle 110-b. In some examples, an inner surface 215-c of the overgrip 105-c may include an adhesive substance or material in order to adhere the overgrip 105-c to the base grip 105-b.

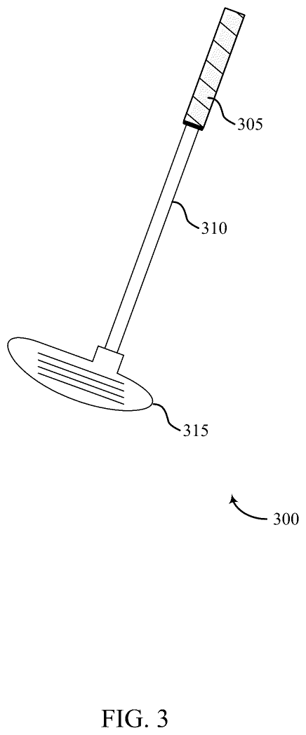

FIG. 3 illustrates an example golf club 300 that supports a biodegradable handgrip 305 in accordance with aspects of the present disclosure. The example golf club 300 may be an example of any golf club (e.g., a putter, wedge, wood, or iron). The example golf club 300 may include a head portion 315 configured to strike a golf ball, a shaft 310, and a biodegradable handgrip 305 configured to be held by a user during play.

The biodegradable handgrip 305 may include a base grip or an overgrip wrapped over the base grip. The biodegradable handgrip 305 be manufactured using conventional techniques aside from the addition of a biodegradable additive. For example, the biodegradable handgrip 305 may be manufactured using a same process as described with reference to the biodegradable handgrip 105 of FIG. 1. In some cases, the biodegradable handgrip 305 may be formed as a tape with an adhesive side that is wrapped around the shaft 310. In some cases, the biodegradable handgrip 305 may be formed as a sheath that slides over the shaft 310. In some cases, an inner surface of a sheath shaped handgrip 305 may include an adhesive material to prevent the sheath shaped handgrip 305 from sliding on the shaft 310.

The addition of the biodegradable additive to synthetic handgrip 105 has been shown to increase the durability of the synthetic handgrip. When applied to golf grips, increased durability may result in less frequent changing of handgrips 305, which may result in time saving, cost saving, and in less plastic waste. Further, increase in durability of the handgrip 305 may result in increased consistency in the feel of the grip to a user.

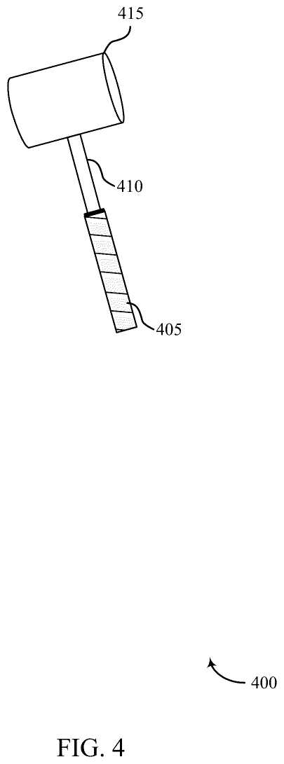

FIG. 4 illustrates an example mallet 400 that supports a biodegradable handgrip 405 in accordance with aspects of the present disclosure. The mallet 400 may include a head portion 415 configured to strike an object (e.g., a nail), a shaft 410, and a biodegradable handgrip 405 configured to be held by a user.

The biodegradable handgrip 405 may include a base grip or an overgrip wrapped over the base grip. The biodegradable handgrip 405 be manufactured using conventional techniques aside from the addition of a biodegradable additive. For example, the biodegradable handgrip 405 may be manufactured using a same process as described with reference to the biodegradable handgrip 105 of FIG. 1. In some cases, the biodegradable handgrip 405 may be formed as a tape with an adhesive side that is wrapped around the shaft 410. In some cases, the biodegradable handgrip 405 may be formed as a sheath that slides over the shaft 410. In some cases, an inner surface of a sheath shaped handgrip 305 may include an adhesive material to prevent the sheath shaped handgrip 405 from sliding on the shaft 410. Although shown as applied to a mallet, a biodegradable handgrip 405 may be applied to any handheld tool that uses a handgrip.

The addition of the biodegradable additive to synthetic handgrip 405 has been shown to increase the durability of the synthetic handgrip. When applied to hand tools such as the mallet, increased durability may result in less frequent changing of handgrips 405, which may result in time saving, cost saving, and in less plastic waste. Further, increase in durability of the handgrip 405 may result in increased consistency in the feel of the grip to a user.

FIG. 5 illustrates a first sample of a control subject 505 and a biodegradable sample 510 that were each subjected to the same Taber abrasion test. Taber abrasion is a test to determine a plastic's resistance to abrasion. Resistance to abrasion may refer to the ability of a material to withstand mechanical action such as rubbing, scraping or erosion. Abrasion may be calculated by haze variation or weight loss.

In a Taber abrasion test, a circular disc is cut from a finished material and placed on a Taber abrasion machine. For example, the biodegradable sample 510 was taken from a roll of a replacement grip for a tennis racquet that includes a biodegradable additive. The biodegradable sample 510 includes a polyester nonwoven base and a polyurethane top coating which would come into contact with a user's hand when applied to a racquet. The polyurethane top coating may provide better traction for a grip. The control subject 505 was taken from a roll of a replacement grip for a tennis racquet that is identical to the biodegradable sample 510 except that the control subject 505 does not include a biodegradable additive.

In the Taber abrasion test, rub-wear action is produced by contact of the test specimen (e.g., the control subject 505 or the biodegradable sample 510) against the sliding rotation of abrading wheels. A Taber abrasion test simulates wear that would come from using a grip over time (e.g., playing tennis with a racquet or golf with a golf club).

The control subject 505 and the biodegradable sample 510 were each subjected to the same Taber abrasion test. As shown, the biodegradable sample 510 remained smooth and retained tackiness, while the control subject 505 lost tackiness and the base material (e.g., the grey polyester nonwoven base) is showing, which demonstrates that the polyurethane top coating of the control subject 505 wore down. Accordingly, the biodegradable sample 510 has a higher durability and retained tackiness better than the control subject 505.

The description set forth herein, in connection with the appended drawings, describes example configurations and does not represent all the examples that may be implemented or that are within the scope of the claims. The detailed description includes specific details for the purpose of providing an understanding of the described techniques. These techniques, however, may be practiced without these specific details.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A biodegradable handgrip, comprising:
a petroleum based material; and
a biodegradable additive blended with the petroleum based material, wherein the biodegradable handgrip is configured to wrap around a shaft.

2. The biodegradable handgrip of claim 1, wherein the biodegradable additive comprises between 0.2 percent and 4 percent of the biodegradable handgrip by weight.

3. The biodegradable handgrip of claim 1, wherein the petroleum based material comprises one of nylon, polyester, or polyurethane.

4. The biodegradable handgrip of claim 1, wherein the biodegradable handgrip comprises a sleeve shape and is configured to wrap around the shaft by sliding over the shaft.

5. The biodegradable handgrip of claim 4, wherein an inner side of the sleeve shape comprises an adhesive material.

6. The biodegradable handgrip of claim 1, wherein the biodegradable handgrip comprises an approximately rectangular strip.

7. The biodegradable handgrip of claim 6, wherein the biodegradable handgrip comprises an adhesive material on a first side of the approximately rectangular strip.

8. The biodegradable handgrip of claim 6, wherein the biodegradable handgrip comprises a cross-sectional width of approximately.

9. The biodegradable handgrip of claim 1, further comprising at least one color additive.

10. The biodegradable handgrip of claim 1, wherein the biodegradable handgrip comprises a racquet base grip.

11. The biodegradable handgrip of claim 1, wherein the biodegradable handgrip comprises a racquet overgrip.

12. The biodegradable handgrip of claim 1, wherein the biodegradable handgrip comprises a golf club grip.

13. The biodegradable handgrip of claim 1, wherein the biodegradable handgrip comprises a hand tool grip.
